(19) United States
(12) Patent Application Publication
(10) Pub. No.: US 2021/0331450 A1
(43) Pub. Date: Oct. 28, 2021

(54) COMPOSITE MEMBER

(71) Applicant: NGK Insulators, Ltd., Nagoya-Shi (JP)

(72) Inventors: Megumi FUJISAKI, Kuwana-Shi (JP); Takahiro TOMITA, Chita-Shi (JP); Yusuke OSHITA, Nagoya-Shi (JP)

(73) Assignee: NGK Insulators, Ltd., Nagoya-Shi (JP)

(21) Appl. No.: 17/305,410

(22) Filed: Jul. 7, 2021

Related U.S. Application Data
(63) Continuation of application No. PCT/JP2020/000541, filed on Jan. 9, 2020.

(30) Foreign Application Priority Data
Jan. 10, 2019 (JP) PCT/JP2019/000585
Oct. 2, 2019 (JP) 2019-182462

(51) Int. Cl. B32B 18/00; B32B 1/08; B32B 15/16; B32B 15/14; B32B 7/027

(52) U.S. Cl. CPC B32B 18/00; B32B 1/08; B32B 15/16; C04B 35/62259; B32B 7/027; B32B 2307/302; B32B 2255/02; B32B 15/14

(57) ABSTRACT

A composite member may include an inorganic porous layer on a surface of metal. The inorganic porous layer may include ceramic fibers. The inorganic porous layer may be constituted of 15 mass % or more of an alumina constituent and 45 mass % or more of a titania constituent.

### TECHNICAL FIELD

The disclosure herein discloses a technique related to a composite member.

### BACKGROUND ART

A composite member of a metal and an inorganic material may be configured by disposing an inorganic protection layer on a surface of the metal. For example, Japanese Patent Application Publication No. 2018-33245 (called Patent Document 1, hereinbelow) describes that, in order mainly to provide heat resistance to a vehicle engine component (metal), an inorganic protection layer coats a surface of the metal. In Patent Document 1, an amorphous inorganic layer (specifically, borosilicate glass) is formed on a surface of the metal and a non-oxide ceramic (specifically, silicon carbide) is formed on a surface of the amorphous inorganic layer in order to prevent separation of the inorganic protection layer from the metal due to a thermal expansion rate difference between the metal and the inorganic protection layer. That is, in Patent Document 1, a reduction layer (borosilicate glass) that reduces the thermal expansion rate difference is interposed between the metal and a functional layer (silicon carbide) that functions as a protection layer. Patent Document 1 improves adhesion between the metal and the functional layer by the amorphous reduction layer.

### SUMMARY OF INVENTION

### Technical Problem

As described, in Patent Document 1, the amorphous reduction layer is interposed between the metal and the functional layer. Therefore, the functional layer has to be formed at a temperature below the softening point of the reduction layer. In other words, materials that can be used for the functional layer are limited to those that can be deposited at temperatures below the softening point of the reduction layer. Thus, the composite member of Patent Document 1 has a low degree of freedom in materials used (for the reduction layer and the functional layer). Further, improvement in heat resistance provided by the composite member of Patent Document 1 is limited due to the use of the amorphous reduction layer. In the field of composite member, constant improvements are desired. The disclosure herein provides a non-conventional and novel composite member.

### Solution to Technical Problem

A composite member disclosed herein may comprise an inorganic porous layer on a surface of metal. The inorganic porous layer may comprise ceramic fibers and be constituted of mass % or more of an alumina constituent and 45 mass % or more of a titania constituent. As described, in this composite member, the inorganic porous layer comprises ceramic fibers. That is, the inorganic porous layer itself can reduce the influence of a thermal expansion rate difference between the metal and the inorganic porous layer. Specifically, the inorganic porous layer can change its shape following deformation (thermal expansion, thermal shrinkage) of the metal, and thus separation of the inorganic porous layer from the metal can be prevented without a reduction layer (amorphous layer, etc.) being interposed between the metal and the inorganic porous layer.

Further, in the composite member, the inorganic “porous layer” is disposed on the surface of the metal. Typically, porous bodies are highly capable of “severing” an environment internal of the porous bodies from an environment external thereof. That is, the above composite member can reduce the influence of external environment on the metal or the influence of the metal on the external environment, and thus it can provide high thermal insulation, high sound insulation (sound absorbency), etc. Further, the above composite member can also reduce adhesion of substances (foreign matter, moisture, etc.) in the external environment to the metal owing to the inorganic porous layer having absorptivity, moisture absorbency, etc. Alternatively, the above composite member can have the metal support a catalyst on its surface using the inorganic porous layer. It should be noted that the term “porous” used in the disclosure herein means that a porosity ratio (void ratio) of the inorganic porous layer is equal to or more than 45 volume %.

Since the composite member comprises the ceramic fibers in the inorganic porous layer, the strength (mechanical strength) of the inorganic porous layer itself is less likely to be decreased. Further, since the inorganic porous layer is constituted of 15 mass % or more of alumina constituent and 45 mass % or more of titania constituent, the inorganic porous layer has a high melting point, and thus it can maintain its shape even when the external environment of the composite member is at a high temperature.

### BRIEF DESCRIPTION OF DRAWINGS

FIG. 1 shows an example of a composite member according to a first embodiment (perspective view);

FIG. 2 shows a partially enlarged view of the composite member according to the first embodiment;

FIG. 3 shows a cross-sectional view of the composite member according to the first embodiment;

FIG. 4 shows a variant of the composite member according to the first embodiment (cross-sectional view);

FIG. 5 shows a variant of the composite member according to the first embodiment (cross-sectional view);

FIG. 6 shows a variant of the composite member according to the first embodiment (cross-sectional view);

FIG. 7 shows an example of a composite member according to a second embodiment (perspective view);

FIG. 8 shows an example of a composite member according to a third embodiment (perspective view);

FIG. 9 shows an example of a composite member according to a fourth embodiment (perspective view);

FIG. 10 shows an example of a composite member according to a fifth embodiment (perspective view);

FIG. 11 shows an example of a composite member according to a sixth embodiment (perspective view):

FIG. 12 shows an example of a composite member according to a seventh embodiment (perspective view);

FIG. 13 shows an example of a composite member according to an eighth embodiment (perspective view);

FIG. 14 shows usage example of a composite member (cross-sectional view); and

FIG. 15 shows results of an experimental example.

### DESCRIPTION OF EMBODIMENTS

A composite member may satisfy the following formula (1), where α1 is a coefficient of thermal expansion of an inorganic porous layer and α2 is a coefficient of thermal expansion of a metal. Separation of the inorganic porous layer from the metal can be prevented for sure.

0.5<α1/α2<1.2 Formula (1):

In the composite member, the inorganic porous layer may comprise plate-shaped ceramic particles. Using the plate-shaped ceramic particles allows a part of ceramic fibers to be replaced with the plate-shaped ceramic particles. Typically, a length (longitudinal dimension) of the plate-shaped ceramic particles is shorter than a length of the ceramic fibers. Therefore, heat transfer pathways in the inorganic porous layer are severed by using the plate-shaped ceramic particles, and thus heat tends to be less transferred in the inorganic porous layer. As a result, thermal insulation of the inorganic porous layer is improved further. It should be noted that the “plate-shaped ceramic particles” means ceramic particles with an aspect ratio of 5 or more and a longitudinal dimension ranging from 5 μm or more to 50 μm or less.

In the composite member, the inorganic porous layer may comprise granular particles ranging from 0.1 μm or more to 10 μm or less. In shaping (firing) the inorganic porous layer, the ceramic fibers are combined to each other via the granular particles, and thereby the resultant inorganic porous layer has high strength. Further, a thickness of the inorganic porous layer may be 1 mm or more. This inorganic porous layer can fully exercise the aforementioned functions (thermal insulation, sound insulation, absorptivity, moisture absorbency, etc.). Since the inorganic porous layer of the composite member comprises the ceramic fibers, the inorganic porous layer with thickness of 1 mm or more can be realized. That is, since the inorganic porous layer comprises the ceramic fibers which are less shrinkable in a shaping process (e.g., firing process) of the inorganic porous layer, the inorganic porous layer can be shaped to have the thickness of 1 mm or more. For example, if the inorganic porous layer did not comprise the ceramic fibers, the inorganic porous layer could shrink and cracks and the like could be thereby caused in the shaping process. If, for example, the inorganic porous layer did not comprise the ceramic fibers, it would be difficult to form the inorganic porous layer such that it has the thickness of 1 mm or more.

Hereinbelow, embodiments of a composite member disclosed herein will be described. The composite member disclosed herein comprises an inorganic porous layer on a surface of metal. The inorganic porous layer comprises ceramic fibers. The inorganic porous layer is constituted of 15 mass % or more and 55 mass % or less of an alumina constituent (Al₂O₃) and 45 mass % or more and 85 mass % or less of a titania constituent (TiO₂). The alumina constituent in the inorganic porous layer may be 25 mass % or more, 30 mass % or more, or 40 mass % or more. The composite member disclosed herein can be suitably used, for example, in a high-temperature environment. As an example, the composite member can be suitably used as a member configuring an automotive exhaust system, such as an exhaust manifold or an exhaust pipe. The composite member disclosed herein can be also suitably used as a heat transfer member that, for example, transfers heat generated at a heat source to a component (e.g., radiator plate) positioned away from the heat source. Alternatively, the composite member can be interposed between a plurality of devices and be suitably used as a partition plate that prevents heat generated at one of the devices from being applied to another of the devices.

The inorganic porous layer may coat the surface of the metal and protect the metal from an external environment. Here, the “external environment” means a space opposite to the metal with the inorganic porous layer interposed between the metal and the space. That is, when the composite member is used as a member configuring an automotive exhaust system as described, the “external environment” corresponds to the internal space of an exhaust manifold, an exhaust pipe, or the like. Alternatively, the inorganic porous layer may coat the surface of the metal and protect (thermally insulate) a component in the external environment of the composite member from heat of the metal. The inorganic porous layer may coat surfaces of two pieces of metal (e.g., metal plates) facing each other with spacing therebetween. In other words, metal plates (a first metal plate and a second metal plate) may be joined to both surfaces of one inorganic porous layer, respectively. It is possible to prevent heat generated at a first device disposed on the first metal plate side from being applied to a second device disposed on the second metal plate side and to release the heat generated at the first device by the first metal plate.

As described, the composite member reduces a thermal influence from the metal onto the external environment and vice versa by the inorganic porous layer. Further, the inorganic porous layer partitions a space in which a plurality of devices is disposed such that thermal influence between the separated spaces is reduced. Thus, it is desirable that a thermal conductivity difference between the metal and the inorganic porous layer is large. Specifically, thermal conductivity of the metal may be 100 times or more the thermal conductivity of the inorganic porous layer. The thermal conductivity of the metal may be 150 times or more, 200 times or more, 250 times or more, or 300 times or more the thermal conductivity of the inorganic porous layer.

The thermal conductivity of the metal may range from 10 W/mK or more to 400 W/mK or less. The thermal conductivity of the metal may be 25 W/mK or more, 50 W/mK or more, 100 W/mK or more, 150 W/mK or more, 200 W/mK or more, 250 W/mK or more, 300 W/mK or more, or 380 W/mK or more. Further, the thermal conductivity of the metal may be 350 W/mK or less, 300 W/mK or less, 250 W/mK or less, 200 W/mK or less, or 150 W/mK or less.

The thermal conductivity of the inorganic porous layer may range from 0.05 W/mK or more to 3 W/mK or less. The thermal conductivity of the inorganic porous layer may be 0.1 W/mK or more, 0.2 W/mK or more, 0.3 W/mK or more, 0.5 W/mK or more, 0.7 W/mK or more, 1 W/mK or more, 1.5 W/mK or more, or 2 W/mK or more. Further, the thermal conductivity of the inorganic porous layer may be 2.5 W/mK or less, 2.0 W/mK or less, 1.5 W/mK or less, 1 W/mK or less, 0.5 W/mK or less, 0.3 W/mK or less, or 0.25 W/mK or less.

The metal may be in a tubular shape (pipe shape), a linear shape (wire shape), or a plate shape (sheet shape), although not limited to having one of those shapes. In case of tubular-shaped metal, the inorganic porous layer may coat an inner surface and/or an outer surface of the tubular-shaped metal. Linear-shaped metal typically has a solid structure. Therefore, in case of the linear-shaped metal, the inorganic porous layer may coat an outer surface of the linear-shaped metal. In case of plate-shaped metal, the inorganic porous layer may coat the entirety of exposed surface of the plate-shaped metal, may coat end face(s) (front face and/or back face) in its thickness direction, may coat end face(s) (side face(s)) in its width direction, or may coat end face(s) in its longitudinal direction. Further, in case of the plate-shaped metal, the inorganic porous layer may coat both a front face of a first plate-shaped metal (a first metal plate) and a back face of a second plate-shaped metal (a second metal plate).

The inorganic porous layer may coat the entire surface of the metal or may coat a part of the surface of the metal. For example, when the inorganic porous layer coats the tubular-shaped metal or the linear-shaped metal, the inorganic porous layer may coat a part of the metal except for end(s) (one end or both ends) of the metal. Further, when the inorganic porous layer coats the inner and outer surfaces of the tubular-shaped metal, part(s) coated by the inorganic porous layer may be different between the inner surface and the outer surface; for example, the inner surface may be coated by the inorganic porous layer from one end to the other end (i.e., the entire inner surface is coated) and the outer surface may be coated except for its end(s). When the inorganic porous layer coats the plate-shaped metal (e.g., end faces in the thickness direction: front and back faces), the inorganic porous layer may coat the front and back faces except for parts thereof (e.g., one end or both ends in the longitudinal direction). Alternatively, part(s) coated by the inorganic porous layer may be different between the front face and the back face; for example, the back face may be entirely coated by the inorganic porous layer and the front face may be coated except for its both ends.

The inorganic porous layer may be constituted of a single material in its thickness direction (in a range from the face in contact with the surface of the metal to the face exposed to the external environment). That is, the inorganic porous layer may be a single layer. The inorganic porous layer may be configured of a plurality of layers having different compositions in the thickness direction. That is, the inorganic porous layer may have a multi-layer structure in which multiple layers are stacked. Alternatively, the inorganic porous layer may have a gradation structure in which the compositions are gradually varied in the thickness direction. When the inorganic porous layer is a single layer, this facilitates manufacturing of the composite member (in a process in which the inorganic porous layer is formed on the metal surface). When the inorganic porous layer has a multi-layer or gradation structure, the inorganic porous layer can be varied in characteristics in the thickness direction. The structure of the inorganic porous layer (single layer, multi-layer structure, gradation structure) can be appropriately selected according to the intended use of the composite member.

The porosity ratio of the inorganic porous layer may range from 45 volume % or more to 90 volume % or less. With the porosity ratio of 45 volume % or more, the inorganic porous layer can fully exercise functions of a porous body, such as thermal insulation, sound insulation, absorptivity, moisture absorbency, and the like. Further, with the porosity ratio of 45 volume % or more, a catalyst can be supported sufficiently using voids in the inorganic porous layer. With the porosity ratio of 90 volume % or less, sufficient strength can be ensured. The porosity ratio of the inorganic porous layer may be 55 volume % or more, 60 volume % or more, or 65 volume % or more. Further, the porosity ratio of the inorganic porous layer may be 85 volume % or less, 80 volume % or less, 70 volume % or less, 65 volume % or less, or 60 volume % or less. When the inorganic porous layer has the multi-layer or gradation structure, the porosity ratio of the inorganic porous layer may be 45 volume % or more and 90 volume % or less as a whole, and the porosity ratio may be varied in the thickness direction. In this case, the inorganic porous layer may include a part with porosity ratio of less than 45 volume % or a part with porosity ratio of more than 90 volume %.

The thickness of the inorganic porous layer may be 1 mm or more, although it depends on the intended use (required performance). When the thickness of the inorganic porous layer is 1 mm or more, the inorganic porous layer can fully exercise functions of a porous body, such as thermal insulation, sound insulation, absorptivity, moisture absorbency, and the like. It should be noted that if ceramic fibers were not used in the inorganic porous layer, the inorganic porous layer would shrink in the manufacturing process (e.g., in the firing process), and thus it would be difficult to maintain the thickness at 1 mm or more. Since the inorganic porous layer disclosed herein comprises the ceramic fibers, the shrinkage in the manufacturing process is diminished, and thus the thickness can be maintained at 1 mm or more. If the thickness of the inorganic porous layer were too large, improvement in properties might not worth the costs (costs for manufacturing and materials). Therefore, the thickness of the inorganic porous layer may be 30 mm or less, 20 mm or less, 15 mm or less, 10 mm or less, or 5 mm or less, although it is not limited thereto.

The inorganic porous layer is constituted of one or more materials of: ceramic particles (granular particles), plate-shaped ceramic particles, and ceramic fibers. The ceramic particles, the plate-shaped ceramic particles, and the ceramic fibers may each contain, as its constituent(s), alumina and/or titania. In other words, the ceramic particles, the plate-shaped ceramic particles, and the ceramic fibers may be constituted of alumina and/or titania. That is, the inorganic porous layer may comprise 15 mass % or more of an alumina constituent and 45 mass % or more of a titania constituent relative to all constituent materials (constituent substances). It should be noted that the inorganic porous layer may comprise any constituent (may or may not comprise the alumina constituent and/or the titania constituent), however, it comprises at least the ceramic fibers.

The ceramic particles may be used as a joint material that joins materials together that constitute a frame of the inorganic porous layer, such as the plate-shaped ceramic particles, the ceramic fibers, and the like. The ceramic particles may be granular particles ranging from 0.1 μm or more to 10 μm or less. The diameter of the ceramic particles may be increased due to sintering and/or the like in the manufacturing process (e.g., in the firing process). That is, the ceramic particles may be granular particles ranging from 0.1 μm or more to 10 μm or less (average particle size before firing) as a raw material of the inorganic porous layer. The ceramic particles may be 0.5 μm or more and 5 μm or less. As a material of the ceramic particles, a metal oxide may be used, for example. Examples of the metal oxide include alumina (Al₂O₃), spinel (MgAl₂O₄), titania (TiO₂), zirconia (ZrO₂), magnesia (MgO), mullite (Al₆O₁₃Si₂), cordierite (MgO.Al₂O₃.SiO₂), yttria (Y₂O₃), steatite (MgO.SiO₂), forsterite (2MgO. SiO₂), lanthanum aluminate (LaAlO₃), strontium titanate (SrTiO₃), and the like. These metal oxides are highly corrosive resistant. Therefore, using one or more of the aforementioned metal oxides as the material of the ceramic particles allows the inorganic porous layer to be suitably used as a protection layer for, for example, a component (e.g., exhaust manifold) of an automotive exhaust system.

The plate-shaped ceramic particles can function as an aggregation material or a reinforcement material in the inorganic porous layer. That is, the plate-shaped ceramic, as with the ceramic fibers, improves the strength of the inorganic porous layer and diminishes the shrinkage of the inorganic porous layer in the manufacturing process. The use of plate-shaped ceramic particles severs heat transfer pathways in the inorganic porous layer. This provides improved thermal insulation when the composite member is used in a high-temperature environment (when the inorganic porous layer is used to insulate heat from the metal), compared with a configuration in which only the ceramic fibers are used as the aggregation material.

The plate-shaped ceramic particles have a rectangular shape or a needle shape and have a longitudinal dimension ranging from 5 μm or more to 100 μm or less. With the longitudinal dimension of 5 μm or more, it is possible to curtail excessive sintering of the ceramic particles. With the longitudinal dimension of 100 μm or less, it is possible to produce the aforementioned effect of severing the heat transfer pathways in the inorganic porous layer, and thus the plate-shaped ceramic particles can be suitably used in the composite member intended to be used in a high-temperature environment. The plate-shaped ceramic particles may have an aspect ratio ranging from 5 or more to 100 or less. With the aspect ratio of 5 or more, it is possible to favorably curtail sintering of the ceramic particles, while with the aspect ratio of 100 or less, it is possible to reduce a decrease in the strength of the plate-shaped ceramic particles themselves. In addition to the aforementioned metal oxides used as the material of the ceramic particles, minerals, clay, and glass such as talc (Mg₃Si₄O₁₀(OH)₂), mica, kaolin, and the like can be used as the material of the plate-shaped ceramic particles.

The ceramic fibers can function as an aggregation material or a reinforcement material in the inorganic porous layer. That is, the ceramic fibers improve the strength of the inorganic porous layer and also diminishes the shrinkage of the inorganic porous layer in the manufacturing process. The ceramic fibers may have a length ranging from 50 μm or more to 200 μm or less. Further, the ceramic fibers may have a diameter (average diameter) ranging from 1 μm to 20 μm. A volume ratio of the ceramic fibers in the inorganic porous layer (volume ratio of the ceramic fibers relative to materials constituting the inorganic porous layer) may range from 5 volume % or more to 25 volume % or less. With 5 volume % or more of the ceramic fibers, it is possible to sufficiently diminish the shrinkage of the ceramic particles in the inorganic porous layer in the manufacturing process (firing process) of the inorganic porous layer. Further, with 25 volume % or less of the ceramic fibers, it is possible to sever the heat transfer pathways in the inorganic porous layer, and thus they can be suitably used in the composite member intended to be used in a high-temperature environment. The same materials as those of the plate-shaped ceramic particles mentioned above can be used as the material of the ceramic fibers.

A content percentage of aggregation and reinforcement materials (which include the ceramic fibers, the plate-shaped ceramic particles, and the like, and will be simply termed aggregation materials) in the inorganic porous layer may range 15 mass % or more to 55 mass % or less. With the content percentage of the aggregation materials in the inorganic porous layer being 15 mass % or more, it is possible to sufficiently diminish the shrinkage of the inorganic porous layer in the firing process. Further, with the content percentage of the aggregation materials in the inorganic porous layer being 55 mass % or less, the aggregation materials are favorably joined together by the ceramic particles. The content percentage of the aggregation materials in the inorganic porous layer may be 20 mass % or more, 30 mass % or more, 50 mass % or more, or 53 mass % or more. Further, the content percentage of the aggregation materials in the inorganic porous layer may be 53 mass % or less, 50 mass % or less, 30 mass % or less, or 20 mass % or less.

As described, both the ceramic fibers and the plate-shaped ceramic particles can function as aggregation materials or reinforcement materials in the inorganic porous layer. However, in order to surely diminish the shrinkage of the inorganic porous layer after the composite member has been manufactured (after the firing), a content percentage of the ceramic fibers in the inorganic porous layer may be at least 5 mass % or more even when both the ceramic fibers and the plate-shaped ceramic particles are used as the aggregation materials. The content percentage of the ceramic fibers may be 10 mass % or more, 20 mass % or more, 30 mass % or more, or 40 mass % or more. Further, the content percentage of the ceramic fibers may be 50 mass % or less, 40 mass % or less, 30 mass % or less, 20 mass % or less, or 10 mass % or less.

When both the ceramic fibers and the plate-shaped ceramic particles are used as the aggregation materials, a ratio (ratio by weight) of the plate-shaped ceramic particles relative to the total aggregation materials may be 70% or less. In other words, the ceramic fibers may account for at least 30% or more of the aggregation materials in mass ratio. The ratio (ratio by weight) of the plate-shaped ceramic particles relative to the total aggregation materials may be 67% or less, 64% or less, 63% or less, 60% or less, or 50% or less. It should be noted that the plate-shaped ceramic particles are not necessarily required as an aggregation material. The ratio of the plate-shaped ceramic particles relative to the total aggregation materials may be 40% or more, 50% or more, 60% or more, 62% or more, 63% or more, or 65% or more. Specifically, the content percentage of the plate-shaped ceramic particles in the inorganic porous layer may be 5 mass % or more, 10 mass % or more, 20 mass % or more, 30 mass % or more, or 33 mass % or more. Further, the content percentage of the plate-shaped ceramic particles may be mass % or less, 33 mass % or less, 30 mass % or less, 20 mass % or less, or 10 mass % or less.

In a composite member intended to be used in a particularly high-temperature environment, the inorganic porous layer may comprise 25 mass % or less of SiO₂. This reduces formation of an amorphous layer in the inorganic porous layer, and thereby heat resistance (durability) of the inorganic porous layer is improved.

To form the inorganic porous layer, a mixture of raw materials including binders, a pore-forming agent, and a solvent may be used other than the ceramic particles, the plate-shaped ceramic particles, and the ceramic fibers. Inorganic binders may be used as the binders. Examples of the inorganic binders include alumina sol, silica sol, titania sol, zirconia sol, and the like. These inorganic binders can provide increased strength to the inorganic porous layer after firing. As the pore-forming agent, a macromolecular pore-forming agent, carbon-based powder, and/or the like can be used. Examples thereof specifically include acryl resin, melamine resin, polyethylene particles, polystyrene particles, carbon black powder, graphite powder, and the like. The pore-forming agent may have any shape according to the purpose, and may have, for example, a spherical shape, a plate shape, a fiber shape, or the like. The porosity ratio and pore size of the inorganic porous layer can be adjusted by selecting an added amount, size, and/or shape of the pore-forming agent. The solvent may be any solvent so long as it can adjust the viscosity of the raw materials without affecting the other materials. As the solvent, water, ethanol, isopropyl alcohol (IPA), or the like can be used.

The inorganic binders are also a constituent material of the inorganic porous layer. Thus, if alumina sol, titania sol, and/or the like are used to form the inorganic porous layer, the inorganic porous layer may comprise 15 mass % or more of the alumina constituent and 45 mass % or more of the titania constituent relative to the total constituent materials including the inorganic binders.

The compositions and raw materials of the inorganic porous layer may be adjusted according to the kind of metal that the inorganic porous layer protects. In the composite member disclosed herein, stainless steel such as SUS430, SUS429, SUS444, or the like, iron, copper, hastelloy, inconel, a nickel alloy, or the like can be used as the metal, although not particularly limited thereto. The compositions and raw materials of the inorganic porous layer may be adjusted according to the coefficient of thermal expansion of the metal used. Specifically, the compositions and raw materials may be adjusted such that the formula 1 shown below is satisfied, where α1 is a coefficient of thermal expansion of the inorganic porous layer and α2 is a coefficient of thermal expansion of the metal. For example, in case of the metal being SUS430, the compositions and raw materials of the inorganic porous layer may be adjusted such that the coefficient α1 of thermal expansion satisfies 6×10⁻⁶/K<α1<14×10⁻⁶/K, or more preferably, such that the coefficient α1 of thermal expansion satisfies 6×10⁻⁶/K<α1<1 11×10⁻⁶/K. In case of the metal being copper, the compositions and raw materials of the inorganic porous layer may be adjusted such that the coefficient α1 of thermal expansion satisfies 8.5×10⁻⁶/K<α1<20×10⁻⁶/K, or more preferably such that the coefficient α1 of thermal expansion satisfies 8.5×10⁻⁶/K<α1<18×10⁻⁶/K. The value “α1/α2” may be 0.55 or more, 0.6 or more, 0.65 or more, 0.75 or more, or 0.8 or more. Further, the value “α1/α2” may be 1.15 or less, 1.1 or less, 1.05 or less, or 1.0 or less.

0.5<α1/α2<1.2 Formula (1):

Regarding the composite member disclosed herein, the inorganic porous layer may be formed on the surface of the metal by applying the aforementioned raw materials on the surface of the metal (inner surface of the tube in case of the tubular-shaped metal), and drying and firing them. As a method of applying the raw materials, dip coating, spin coating, spray coating, slit die coating, thermal spraying, aerosol deposition (AD) method, printing, application with a brush, application with a pallet, mold-casting forming, or the like can be used. If the inorganic porous layer with large thickness is required or if the inorganic porous layer has the multilayer structure, the required thickness or the multilayer structure may be obtained by repeating the application and drying of the raw materials for multiple times. The aforementioned application methods can be used as an application method to form a coating layer (which will be described later).

The composite member disclosed herein may further comprise a coating layer disposed on a surface of the inorganic porous layer that is opposite to a surface thereof on which the metal is disposed. That is, the inorganic porous layer may be interposed between the metal and the coating layer. The coating layer may be disposed over the entire surface of the inorganic porous layer (that is opposite to the surface thereof on which the metal is disposed) or on a part of the surface of the inorganic porous layer. The coating layer can protect (reinforce) the inorganic porous layer.

The material of the coating layer may be a porous ceramic or dense ceramic. Examples of the porous ceramic used in the coating layer include zirconia (ZrO₂), partially stabilized zirconia, stabilized zirconia, and the like. The examples further include yttria-stabilized zirconia (ZrO₂—Y₂O₃: YSZ), metal oxides obtained by adding Gd₂O₃, Yb₂O₃, Er₂O₃, and the like to YSZ, ZrO₂—HfO₂—Y₂O₃, ZrO₂—Y₂O₃—La₂O₃, ZrO₂—HfO₂—Y₂O₃—La₂O₃, HfO₂—Y₂O₃, CeO₂—Y₂O₃, Gd₂Zr₂O₇, Sm₂Zr₂O₇, LaMnAl₁₁O₁₉, YTa₃O₉, Y_{0.7}La_{0.3}Ta₃O₉, Y_{1.08}Ta_{2.76}Zr_{0.24}O₉, Y₂Ti₂O₇, LaTa₃O₉, Yb₂Si₂O₇, Y₂Si₂O₇, Ti₃O₅, and the like. Examples of the dense ceramic used in the coating layer include alumina, silica, zirconia, and the like. Removing the ceramic fibers from the aforementioned constituent materials of the inorganic porous layer provides a low porosity ratio (density property), and this is used for the coating layer. By using the porous or dense ceramic as the coating layer, the inorganic porous layer can be reinforced and separation of the inorganic porous layer from the surface of the metal can be reduced. Using the dense ceramic as the coating layer inhibits, for example, a high-temperature gas from passing through the inorganic porous layer and/or from staying within the inorganic porous layer. As a result, it is expected to produce an effect of reducing heat transfer from the high-temperature gas to the metal. Further, using the dense ceramic as the coating layer improves an effect of electrically insulating the metal from the external environment.

The material of the coating layer may be a porous glass or dense glass. By using the porous or dense glass as the coating layer as well, the inorganic porous layer can be reinforced and separation of the inorganic porous layer from the surface of the metal can be reduced. The material of the coating layer may be a metal (which is a separate component from the metal protected by the inorganic porous layer). By disposing a metal layer on the surface of the inorganic porous layer, it is possible to reflect radiation heat from the external environment, and thus the application of heat to the metal (the metal protected by the inorganic porous layer) can be reduced further.

### EMBODIMENTS

### First Embodiment

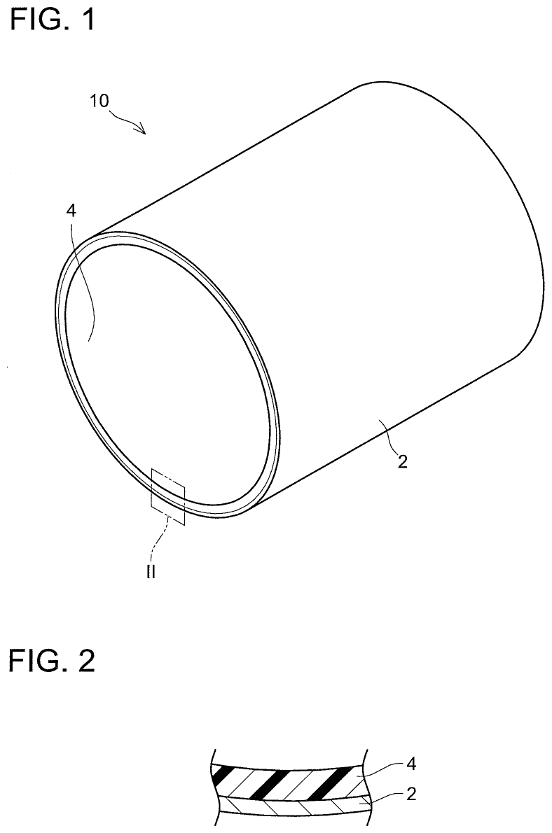

Referring to FIGS. 1 to 3, a composite member 10 will be described. The composite member 10 comprises a porous protection layer 4 on an inner surface of a tubular metal (metal tube) 2 constituted of SUS430. The porous protection layer 4 is an example of the inorganic porous layer. The porous protection layer 4 is joined to the inner surface of the metal 2 (see FIGS. 1 and 2). The composite member 10 was manufactured by submerging the metal 2, with its outer surface masked, into a slurry of raw materials and drying and firing it. The slurry of raw materials was produced by mixing alumina fibers (average fiber length 140 μm), plate-shaped alumina particles (average particle size 6 μm), titania particles (average particle size 0.25 μm), alumina sol (1.1 mass % in amount of alumina), acrylic resin (average particle size 8 μm), and ethanol. The slurry of raw materials was adjusted such that it had a viscosity of 2000 mPa·s.

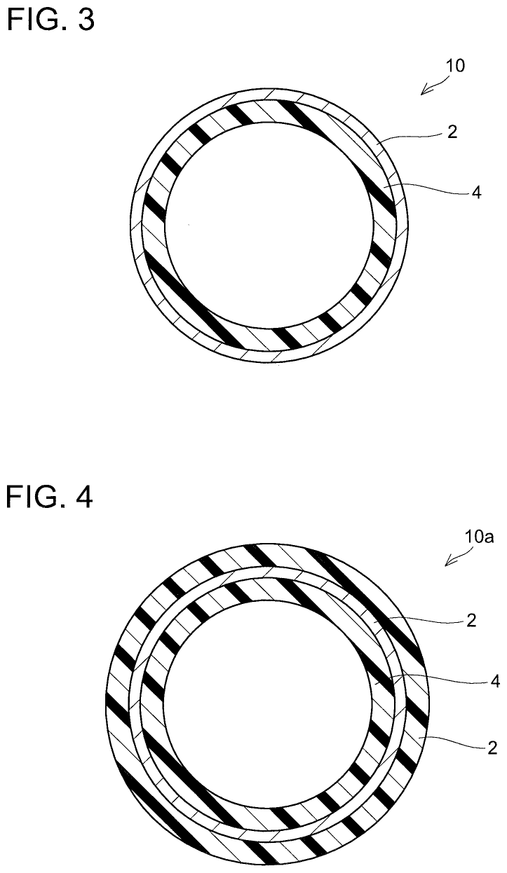

After the raw materials were applied to the inner surface of the metal 2 by submerging the metal 2 in the slurry of raw materials, the metal 2 was dried in a dryer for an hour at 200° C. (in atmospheric environment). Thereby, a porous protection layer of 300 μm was formed on the inner surface of the metal 2. After this, the process of submerging the metal 2 in the slurry of raw materials and drying it was repeated three times, and thereby a porous protection layer of 1.2 mm was formed on the inner surface of the metal 2. Then, the metal 2 was fired in an electric furnace for three hours at 800° C. (in atmospheric environment), and thereby the composite member 10 was manufactured. The porous protection layer 4 was formed over the entire inner surface of the metal 2 (see FIG. 3). The resultant composite member 10 included the porous protection layer 4 with a porosity ratio of 61 volume % and had a coefficient of thermal expansion of 7×10⁻⁶K⁻¹. It was confirmed that in the composite member 10, the titania particles were interposed between the surface (the inner surface) of the metal 2 and aggregated materials (the alumina fibers and the plate-shaped alumina particles) and joined the surface of the metal 2 to the aggregated materials, although this is not shown.

Referring to FIGS. 4 to 6, variants of the composite member 10 (composite members 10a, 10b, and 10c) will be described. FIGS. 4 to 6 each show a portion corresponding to FIG. 3 (cross-sectional view) regarding the composite member 10.

As shown in FIG. 4, in the composite member 10a, the porous protection layer 4 is joined to the inner and outer surfaces of the metal 2. The composite member 10a was manufactured through substantially the same processes as those of the composite member 10, although the metal 2 was not masked. The porous protection layer 4 was formed over the entire inner surface and the entire outer surface of the metal 2.

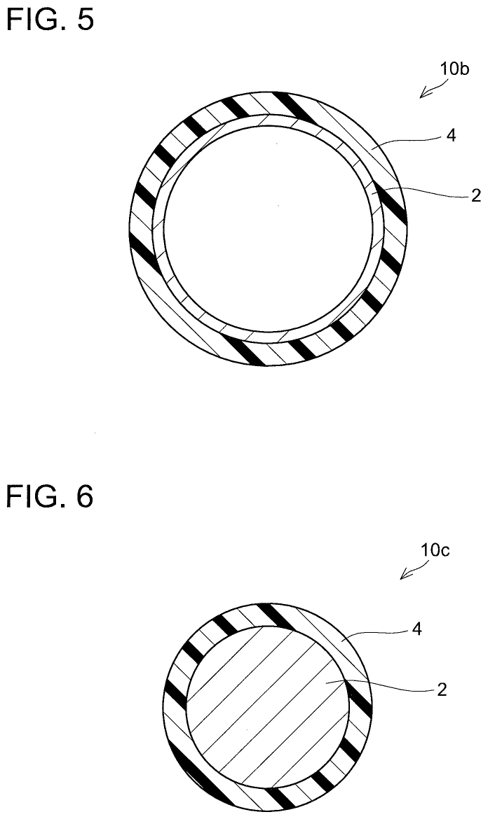

As shown in FIG. 5, in the composite member 10b, the porous protection layer 4 is joined to the outer surface of the metal 2. The composite member 10b was manufactured through substantially the same processes as those of the composite member 10, although the inner surface of the metal 2 was masked. The porous protection layer 4 was formed over the entire outer surface of the metal 2.

As shown in FIG. 6, in the composite member 10c, the metal 2 has a linear shape (line shape) and does not have a hole at the center (see FIGS. 1 to 5 for comparison). That is, the metal 2 is solid in the composite member 10c. In the composite member 10c, the porous protection layer 4 is joined to the outer surface of the metal 2. The composite member 10c was manufactured through substantially the same processes as those of the composite member 10, although the metal 2 was not masked. The porous protection layer 4 was formed over the entire inner surface and the entire outer surface of the metal 2.

### Second to Eighth Embodiments

Composite members according to second to eights embodiments (composite members 210 to 810) will be described hereinbelow. The composite members 210 to 810 are different from the composite members 10 (and 10a to 10c) in the shape of metal, the position or range where the porous protection layer is formed, and/or whether a coating layer is present or absent. The composite members 210 to 810 were manufactured through substantially the same processes as those of the composite member 10, although position(s) to be masked, forming conditions for the porous protection layer, and firing conditions after formation of the porous protection layer, and the like were adjusted according to the intended use. In the following description, the same features as those of the composite member 10 (and 10a to 10c) may not be described.

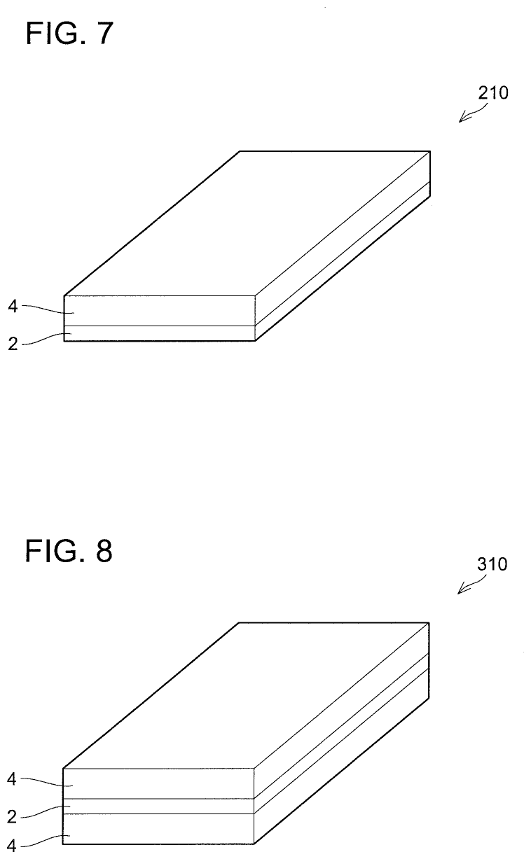

In the composite member 210 (second embodiment) shown in FIG. 7, the porous protection layer 4 is joined to a surface of flat-plate-shaped metal 2 (one of end faces thereof in its thickness direction). In the composite member 310 (third embodiment) shown in FIG. 8, the porous protection layers 4 are joined respectively to both surfaces of the flat-plate-shaped metal 2 (both the end faces in the thickness direction). The composite members 210 and 310 each can be used suitably as a material of a thermally conductive member, which will be described later.

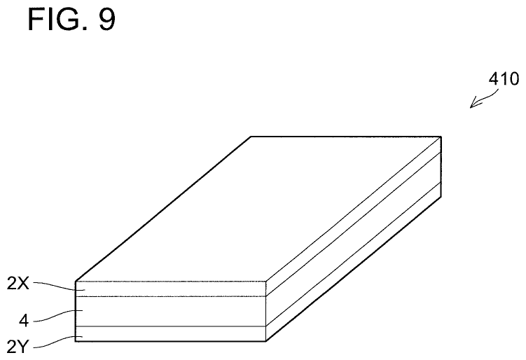

In the composite member 410 (fourth embodiment) shown in FIG. 9, metal plates (a first metal plate 2X and a second metal plate 2Y) are joined respectively to both surfaces (front and back faces) of the porous protection layer 4. In other words, one porous protection layer 4 is connected to the two metal plates (the first metal plate 2X and the second metal plate 2Y) facing each other with an interval therebetween. The composite member 410 can be used suitably as a partition plate between two devices. The first metal plate 2X and the second metal plate 2Y can release heat generated in the devices. Further, the porous protection layer 4 can reduce the application of heat from one of the devices (e.g., the device disposed on the first metal plate 2X side) to the other device (the device disposed on the second metal plate 2Y side).

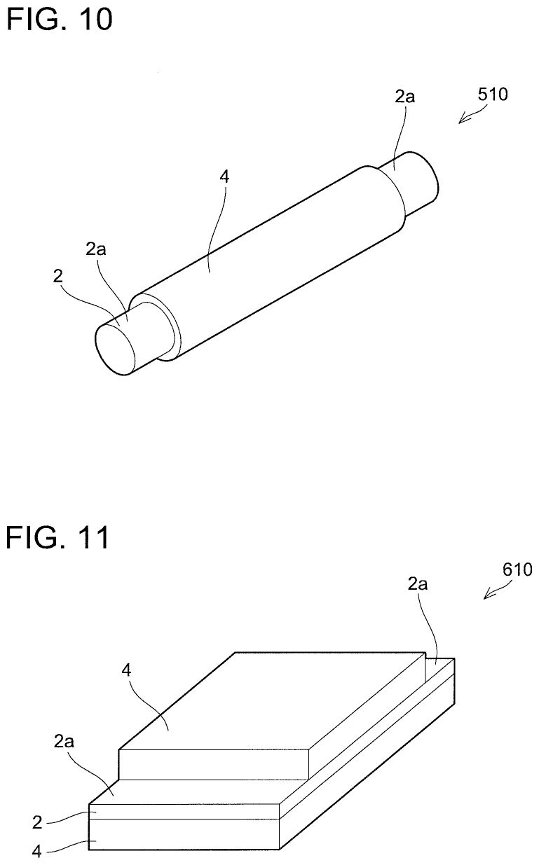

The composite member 510 (fifth embodiment) shown in FIG. 10 is a variant of the composite member 10c (see FIG. 6). In the composite member 510, longitudinal ends (both ends) 2a of the linear-shaped metal 2 are exposed. That is, in the composite member 510, the porous protection layer 4 is joined to an intermediate portion of the metal 2 except for the ends 2a. The composite member 510 can be used suitably as a thermally conductive member that transfers heat at one of the ends 2a to the other end 2a. Further, the composite member 510 can reduce the application of heat to component(s) around the intermediate portion since the porous protection layer 4 is disposed over the intermediate portion. The feature of the composite member 510 (the porous protection layer being joined to the intermediate portion of the metal except for the longitudinal ends) can be also applied to the composite members 10, 10a, and 10b.

The composite member 610 (sixth embodiment) shown in FIG. 11 is a variant of the composite member 310 (see FIG. 8). In the composite member 610, on one of the surfaces (back surface) of the flat-plate shaped metal 2, one porous protection layer 4 is joined to the entirety of the surface, while on another surface (front surface) of the metal 2, another porous protection layer 4 is joined to an intermediate portion except for longitudinal ends (both ends) 2a of the metal 2. As with the composite member 510, the composite member 610 can be used suitably as a thermally conductive member that transfers heat at one of the ends 2a to the other end 2a. On the both surfaces of the metal 2, the porous protection layers 4 may be joined to the intermediate portions except for the ends 2a of the metal 2. Further, the feature of the composite member 610 (the porous protection layer(s) being joined to the intermediate portion(s) except for the longitudinal ends of the metal) can be also applied to the composite member 210.

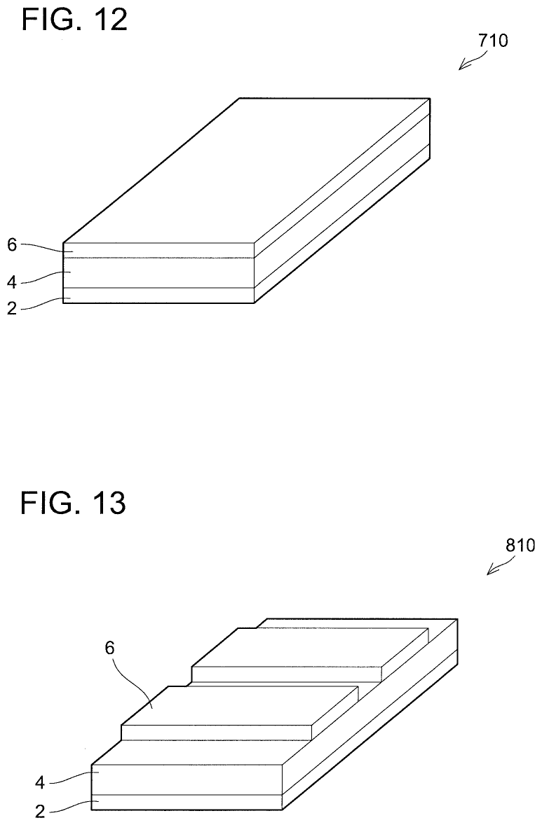

The composite member 710 (seventh embodiment) shown in FIG. 12 is a variant of the composite member 210 (see FIG. 7). In the composite member 710, a coating layer 6 is disposed on a surface of the porous protection layer 4 (opposite surface to the surface where the metal 2 is disposed). After the porous protection layer 4 was formed on the surface of the metal 2, the coating layer 6 was formed by applying a slurry of raw materials onto the surface of the porous protection layer 4 with a spray and drying and firing it. The slurry of raw materials used to form the coating layer 6 was produced by mixing plate-shaped alumina particles (average particle size 6 μm), titania particles (average particle size 0.25 μm), alumina sol (1.1 mass % in amount of alumina), acrylic resin (average particle size 8 μm), and ethanol. That is, the slurry of raw materials used to form the coating layer 6 is the same as the slurry of raw materials used to form the porous protection layer 4 except that the former does not contain the alumina fibers. The coating layer 6 has a dense structure compared with the porous protection layer 4, and thus it functions as a reinforcement for the porous protection layer 4. The materials of the coating layer 6 can be appropriately changed to, for example, the aforementioned materials according to the intended use.

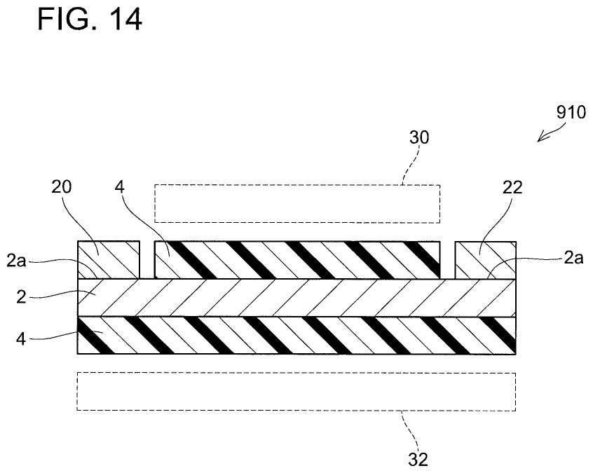

The composite member 810 (eighth embodiment) shown in FIG. 13 is a variant of the composite member 710 (see FIG. 12). In the composite member 810, the coating layer 6 is disposed intermittently (partially) on the surface of the porous protection layer 4 in a longitudinal direction of the composite member 810. For example, when a difference in coefficient of thermal expansion is large between the coating layer 6 and the porous protection layer 4, it is possible to reduce separation of the coating layer 6 from the porous protection layer 4 by intermittently disposing the coating layer 6 on the surface of the porous protection layer 4. The feature of the composite members 710 and 810 (the coating layer being disposed on the surface of the porous protection layer) can be applied to the composite members 10, 10a to 10c, 210, 310, 510, and 610.

(Thermally Conductive Member)

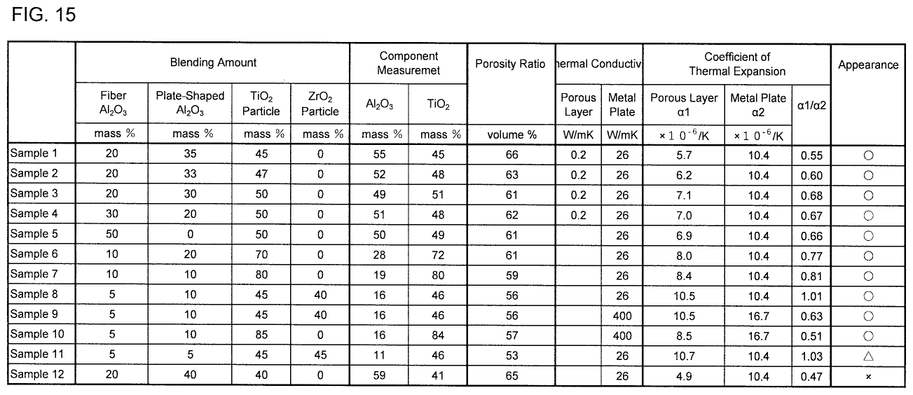

Referring to FIG. 14, an example of use of the above-described composite members (as a thermally conductive member 910) will be described. It should be noted that the thermally conductive member 910 uses the composite member 610 (see FIG. 11), however, any of the other composite members described above can be also used instead of the composite member 610. In the thermally conductive member 910, one porous protection layer 4 is joined to the entire back surface of the metal 2 and another porous protection layer 4 is joined to an intermediate portion of the front surface of the metal 2 (portion except for longitudinal ends 2a). That is, on the front surface of the metal 2, the porous protection layer 4 is not joined to the ends 2a. A heat generator 20 and a heat dissipater 22 are connected to the ends 2a, respectively. Heat received by the heat generator 20 travels through the metal 2 and is then released at the heat dissipater 22 (radiator plate). Since the porous protection layers 4 are joined to the front surface (the intermediate portion) and the back surface in the thermally conductive member 910, heat radiation from the metal 2 is reduced between the heat generator 20 and the heat dissipater 22. Thus, it is possible to reduce the application of heat to devices positioned in a space 30 near the front surface of the thermally conductive member 910 and in a space 32 near the back surface of the thermally conductive member 910.

### Experimental Example

As described, the porous protection layer was manufactured by producing the slurry of raw materials in which the alumina fibers, plate-shaped alumina particles, titania particles, alumina sol, acrylic resin, and ethanol are mixed, submerging the metal in the slurry of raw materials, and then drying and firing it. In the present experimental example, in order to see how amounts of the alumina and titania constituents affect the characteristics of the porous protection layer, ratios of the alumina fibers, the plate-shaped alumina particles, and the titania particles were varied and resultant porous protection layers were observed after firing.

Specifically, slurries of raw materials with varied ratios of the alumina fibers, plate-shaped alumina particles, titania particles, and zirconia particles as shown in FIG. 15 were produced by mixing the alumina fibers, plate-shaped alumina particles, titania particles, and zirconia particles such that the total amounts to 100 mass %, further adding the alumina sol of 10 mass % (1.1 mass % in amount of alumina) and acrylic resin 40 mass % thereto in outer percentage, and adjusting the viscosities of the slurries by ethanol. The plate-shaped alumina particles were not used in a sample 5, and the zirconia particles were not used in samples 1 to 7, 11, or 13. After that, the slurries of raw materials were applied to SUS430 plates for samples 1 to 8, 11, and 12 and were applied to copper plates for samples 9 and 10. The slurries were dried for an hour at 200° C. in the atmospheric environment and then fired for three hours at 800° C. in the atmospheric environment. For each of the samples, the number of times the slurry of raw materials is applied (how many times the metal plate (SUS430 plate or copper plate) is submerged) was adjusted such that the porous protection layer of approximately 1.2 mm was formed on the metal plate.

It should be noted that the present experimental example aims to see how the amounts of the alumina constituent (the alumina fibers and the plate-shaped alumina particles) and the titania component affect the appearances of porous protection layers (whether cracks, separation, and/or the like are observed or not), and thus thermal insulation properties of the porous protection layers was not evaluated.

The appearances of the samples after firing were evaluated. The appearance evaluation was conducted by visually checking whether cracks and/or separation were observed or not. In FIG. 15, a sample in which cracks and separation were not observed is shown with “∘”, a sample in which cracks or separation was observed is shown with “Δ”, and a sample in which both cracks and separation were observed is shown with “x”.

Further, for each of the created samples 1 to 12, ratios (mass %) of the alumina constituent and the titania constituent in the porous protection layer, the porosity ratio (volume %) of the porous protection layer, and coefficients of thermal expansion of the porous protection layer and the metal plate were also measured. For the alumina and titania constituents, amounts of aluminum and titanium were measured using an ICP emission analyzer (manufactured by Hitachi High-Tech Corporation. PS3520UV-DD), and those amounts were translated into oxides (Al₂O₃, TiO₂).

Each porosity ratio was calculated by the following formula (2), using a total pore volume (cm³/g) measured by a mercury porosimeter according to JIS R1655 (test methods for pore size distribution of fine ceramic green body by mercury porosimetry) and an apparent density (g/cm³) measured by a gas replacement-type densimeter (manufactured by Micromeritics Instrument Corp., AccuPyc 1330).

Porosity ratio (%)=total pore volume/((1/apparent density)+total pore volume)×100 Formula 2:

For the measurement of coefficients of thermal expansion, measurement samples were prepared by shaping the aforementioned slurries of raw materials into bulk bodies of 3 mm×4 mm×20 mm and then firing the bulk bodies at 800° C. After that, the measurement samples were measured using a thermal dilatometer according to JIS R1618 (measuring method of thermal expansion of fine ceramics by thermomechanical analysis). The porous protection layers and the metal plates were separately measured in the measurement of coefficients of thermal expansion.

Further, thermal conductivity was measured for each of the porous protection layers of the samples 1 to 4 and each of the metal plates of the samples 1 to 12. The thermal conductivity measurement was conducted for the porous protection layers and the metal layers separately. Each thermal conductivity was calculated by multiplying thermal diffusivity, specific heat capacity, and bulk density. The thermal diffusivity was measured using a laser-flash-method thermal constant measuring device and the specific heat capacity was measured using a DSC (differential scanning calorimeter) under the room temperature according to JIS R1611 (measurement methods of thermal diffusivity, specific heat capacity, and thermal conductivity for fine ceramics by flash method). The bulk density (g/cm³) of each metal plate was calculated by measuring the weight of a bulk body of φ10 mm×thickness 1 mm and then dividing the weight by its volume. The bulk density (g/cm³) of each porous protection layer was calculated by the following formula (3). For the thermal diffusivity and specific heat capacity, thermal diffusivity measurement samples and specific heat capacity measurement samples were prepared by shaping the aforementioned slurries of raw materials into bulk bodies of φ10 mm×1 mm thickness and bulk bodies of φ5 mm×1 mm thickness, respectively, and then firing those bulk bodies at 800° C., and the measurement samples were measured. The measurement results are shown in FIG. 15.

Bulk density of porous protection layer=apparent density×(1−porosity ratio (%)/100) Formula (3):

As shown in FIG. 15, regarding the samples 1 to 10, neither cracks nor separation was observed in their porous protection layers after firing. On the other hand, cracks were observed in the sample 11, although separation was not observed. Further, both cracks and separation were observed in the sample 12. This result indicates that the amount of alumina constituent (the alumina fibers and the plate-shaped alumina particles) being small (less than 15 mass %) or the amount of titania constituent being small (less than 45 mass %) in the porous protection layer allows a force to act on between the metal and the porous protection layer during the firing process, and thereby the characteristics of the porous protection layer are degraded. Specifically, it is inferred that the cracks occurred in the porous protection layer in the sample 11 because the bonding force between ceramics (particles, fibers) was decreased due to the ratio of alumina constituent being less than 15 mass %. Further, it is inferred that the cracks occurred in the porous protection layer in the sample 12 because the bonding force between ceramics was decreased due to the ratio of titania constituent being less than 45 mass %. In addition, the sample 12 contained a small amount of titania constituent (titania particles) which has a high coefficient of thermal expansion and had a small thermal expansion coefficient ratio relative to the metal (α1/α2) (less than 0.5), and thus it is inferred that the porous protection layer separated from the metal due to the thermal expansion difference between the metal and the porous protection layer. As above, it has been confirmed that the porous protection layers comprising mass % or more of the alumina constituent and 45 mass % or more of the titania constituent are less likely to experience deterioration, such as cracks and separation, after fired.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A composite member comprising an inorganic porous layer on a surface of metal, wherein
the inorganic porous layer comprises ceramic fibers and is constituted of 15 mass % or more of an alumina constituent and 45 mass % or more of a titania constituent.

2. The composite member according to claim 1, wherein thermal conductivity of the metal is 100 times or more thermal conductivity of the inorganic porous layer.

3. The composite member according to claim 2, wherein the thermal conductivity of the inorganic porous layer ranges from 0.05 W/mK or more to 3 W/mK or less.

4. The composite member according to claim 3, wherein the thermal conductivity of the metal ranges from 10 W/mK or more to 400 W/mK or less.

5. The composite member according to claim 4, wherein the composite member satisfies a following formula (1), where α1 is a coefficient of thermal expansion of the inorganic porous layer and α2 is a coefficient of thermal expansion of the metal.
0.5<α1/α2<1.2 Formula (1):

6. The composite member according to claim 5, wherein the inorganic porous layer comprises plate-shaped ceramic particles.

7. The composite member according to claim 6, wherein the inorganic porous layer comprises granular particles ranging from 0.1 μm or more to 10 μm or less.

8. The composite member according to claim 7, wherein a thickness of the inorganic porous layer is 1 mm or more.

9. The composite member according to claim 8, wherein the metal is in a plate shape.

10. The composite member according to claim 9, further comprising a coating layer disposed on a surface of the inorganic porous layer that is opposite to a surface thereof on which the metal is disposed.

11. The composite member according to claim 2, wherein the thermal conductivity of the metal ranges from 10 W/mK or more to 400 W/mK or less.

12. The composite member according to claim 1, wherein the composite member satisfies a following formula (1), where α1 is a coefficient of thermal expansion of the inorganic porous layer and α2 is a coefficient of thermal expansion of the metal.
0.5<α1/α2<1.2 Formula (1):

13. The composite member according to claim 1, wherein the inorganic porous layer comprises plate-shaped ceramic particles.

14. The composite member according to claim 1, wherein the inorganic porous layer comprises granular particles ranging from 0.1 μm or more to 10 μm or less.

15. The composite member according to claim 1, wherein a thickness of the inorganic porous layer is 1 mm or more.

16. The composite member according to claim 1, wherein the metal is in a plate shape.

17. The composite member according to claim 1, wherein the metal is in a tubular shape.

18. The composite member according to claim 1, wherein the metal is in a linear shape.

19. The composite member according to claim 1, further comprising a coating layer disposed on a surface of the inorganic porous layer that is opposite to a surface thereof on which the metal is disposed.

20. The composite member according to claim 8, wherein the metal is in a tubular shape.

21. The composite member according to claim 8, wherein the metal is in a linear shape.
